(19) United States
(12) Patent Application Publication
(10) Pub. No.: US 2026/0084568 A1
(43) Pub. Date: Mar. 26, 2026

(54) Electric Work Vehicle

(71) Applicant: Kubota Corporation, Osaka-shi (JP)

(72) Inventors: Takeshi Satozono, Osaka (JP); Yuichi Miyake, Osaka (JP); Shotaro Ikemoto, Osaka (JP)

(21) Appl. No.: 19/336,634

(22) Filed: Sep. 23, 2025

(30) Foreign Application Priority Data
Sep. 24, 2024 (JP) 2024-165398

(51) Int. Cl. B60L 53/62; B60K 35/28; B60L 53/14; B60L 58/10; B60Q 5/00; B60Q 9/00

(52) U.S. Cl. CPC B60L 53/62; B60K 35/28; B60L 53/14; B60L 58/10; B60Q 5/005; B60Q 9/00; B60K 2360/178; B60L 2200/40

(57) ABSTRACT

An electric work vehicle includes a battery; a motor drivable by electric power supplied from the battery; a travel device drivable by the motor; a power supply unit electrically connected to the battery and connectable to a charger; a notifier; a notification control unit configured to control the notifier; and a charging determination unit configured to determine whether or not the battery is being charged normally. While the charger is connected to the power supply unit, the notification controller is configured to, in response to the battery not being charged normally while the charger is connected to the power supply unit with the electric work vehicle being in a key-off state, cause the notifier to provide an abnormality notification for notification that the battery is not being charged normally.

### CROSS-REFERENCE TO RELATED APPLICATION

This application claims priority to Japanese Patent Application No. 2024-165398 filed Sep. 24, 2024, the disclosure of which is hereby incorporated by reference in its entirety.

### BACKGROUND OF THE INVENTION

### Field of the Invention

The present invention relates to an electric work vehicle including a battery and a motor driven by electric power supplied from the battery.

### Description of Related Art

An electric work vehicle described in Japanese Unexamined Patent Application Publication No. 2013-248918 (JP 2013-248918) has been already known as the above electric work vehicle, for example. The electric work vehicle travels by travel devices (“front wheels” and “rear wheels”in JP 2013-248918) driven by a motor (an “electric motor”in JP 2013-248918).

JP 2013-248918 does not describe details of a configuration for charging the battery. Here, it is considered that the electric work vehicle described in JP 2013-248918 may include a power supply unit electrically connected to the battery and connectable to a charger. With this configuration, when the charger is connected to the power supply section, the battery can be charged.

However, in a case where the charger is connected to the power supply unit in such an electric work vehicle, it is expected that the battery may not be charged normally due to a malfunction or the like of the charger, for example. In this case, the user may not notice that the battery is not being charged normally. Particularly, in a case where the electric work vehicle is in the key-off state, a display device or the like in the electric work vehicle is also often turned off. Since an indicator or the like indicating the charging state of the battery is also not displayed in such a state, it is difficult for the user to notice that the battery is not being charged normally.

If the user does not notice that the battery is not being charged normally, the battery may be uncharged when the user is to use the electric work vehicle next. As a result, the user cannot use the electric work vehicle.

### SUMMARY OF THE INVENTION

An object of the present invention is to provide an electric work vehicle that allows a user to easily notice that a battery is not being charged normally in a case where the battery is not being charged normally while a charger is connected to a power supply unit with the electric work vehicle being in the key-off state.

An electric work vehicle according to one aspect of the present invention includes: a battery; a motor drivable by electric power supplied from the battery; a travel device drivable by the motor; a power supply unit electrically connected to the battery and connectable to a charger; a notifier; a notification control unit configured to control the notifier; and a charging determination unit configured to determine whether or not the battery being charged normally while the charger is connected to the power supply unit, the notification controller being configured to, in response to the battery not being charged normally while the charger is connected to the power supply unit with the electric work vehicle being in a key-off state, cause the notifier to provide an abnormality notification for notification that the battery is not being charged normally.

In this configuration, in a case where the battery is not being charged normally while the charger is connected to the power supply unit with the electric work vehicle being in the key-off state, abnormality notification is performed. This allows a user to easily notice that the battery is not being charged normally.

Accordingly, with this configuration, it is possible to achieve the electric work vehicle that allows the user to easily notice that the battery is not being charged normally in a case where the battery is not being charged normally while the charger is connected to the power supply unit with the electric work vehicle being in the key-off state.

The electric work vehicle may further include a driving section, wherein the notifier is a meter panel provided in the driving section, and the notification control unit is a display control unit configured to control the meter panel in such a manner as to cause the meter panel to display, as the abnormality notification, an abnormal status indicator indicating that the battery is not being charged normally.

With this configuration, the abnormality notification is performed (the abnormal status indicator is displayed) with the use of the meter panel generally provided in the electric work vehicle. Accordingly, it is not necessary to newly provide an exclusive device for performing the abnormality notification. This makes it possible to easily avoid an increase in manufacturing costs.

The electric work vehicle may be further configured such that the display control unit turns off the meter panel after a predetermined time has elapsed since start of the display of the abnormal status indicator.

With this configuration, the meter panel is automatically turned off. This makes it possible to reduce power consumption of the meter panel.

The electric work vehicle may be further configured such that the display controller is configured to, in response to the battery being charged normally while the charger is connected to the power supply unit with the electric work vehicle being in the key-off state, cause the meter panel to display a normal status indicator indicating that the battery is being charged normally.

With this configuration, in a case where the battery is being charged normally while the charger is connected to the power supply unit with the electric work vehicle being in the key-off state, the normal status indicator is displayed on the meter panel. This allows the user to find that the battery is being charged normally.

The electric work vehicle may be further configured such that the power supply unit and the meter panel is disposed on an identical lateral side of a lateral center of a body of the electric work vehicle.

With this configuration, at the time when the user connects the charger to the power supply unit, the user can easily recognize the meter panel visually. Hereby, the user can easily notice the abnormal status indicator at the time when the abnormal status indicator is displayed on the meter panel.

The electric work vehicle may be further configured such that the power supply unit is disposed rearward of the meter panel.

With this configuration, at the time when the user connects the charger to the power supply unit, the user can easily recognize the meter panel visually. Hereby, the user can easily notice the abnormal status indicator at the time when the abnormal status indicator is displayed on the meter panel.

The electric work vehicle may be further configured such that the notifier is an audio output device, and the notification control unit is an audio control unit configured to control the audio output device in such a manner as to cause the audio output device to output, as the abnormality notification, an error sound indicating that the battery is not being charged normally.

With this configuration, the abnormality notification is performed by outputting the error sound. Hereby, regardless of where the user is looking, the user can easily notice that the battery is not being charged normally.

### BRIEF DESCRIPTION OF THE DRAWINGS

FIG. 1 is a left side view of an electric work vehicle;

FIG. 2 is a plan view of the electric work vehicle;

FIG. 3 is a block diagram illustrating a configuration related to the control of a meter panel;

FIG. 4 is a flowchart of a display control flow;

FIG. 5 is a view illustrating a meter panel displaying a normal status indicator;

FIG. 6 is a view illustrating the meter panel displaying an abnormal status indicator; and

FIG. 7 is a flowchart of a control flow in (8) in Other Embodiments.

### DESCRIPTION OF THE INVENTION

An embodiment to carry out the present invention will be described with reference to the drawings. In the following description, the direction of an arrow F in the drawings represents “forward,” the direction of an arrow B represents “rearward,” the direction of an arrow “L” represents “leftward,” and the direction of an arrow R represents “rightward,” unless otherwise specified. Besides, in the drawings, the direction of an arrow U represents “upward,” and the direction of an arrow D represents “downward.”

### Overall Configuration of Electric Work Vehicle

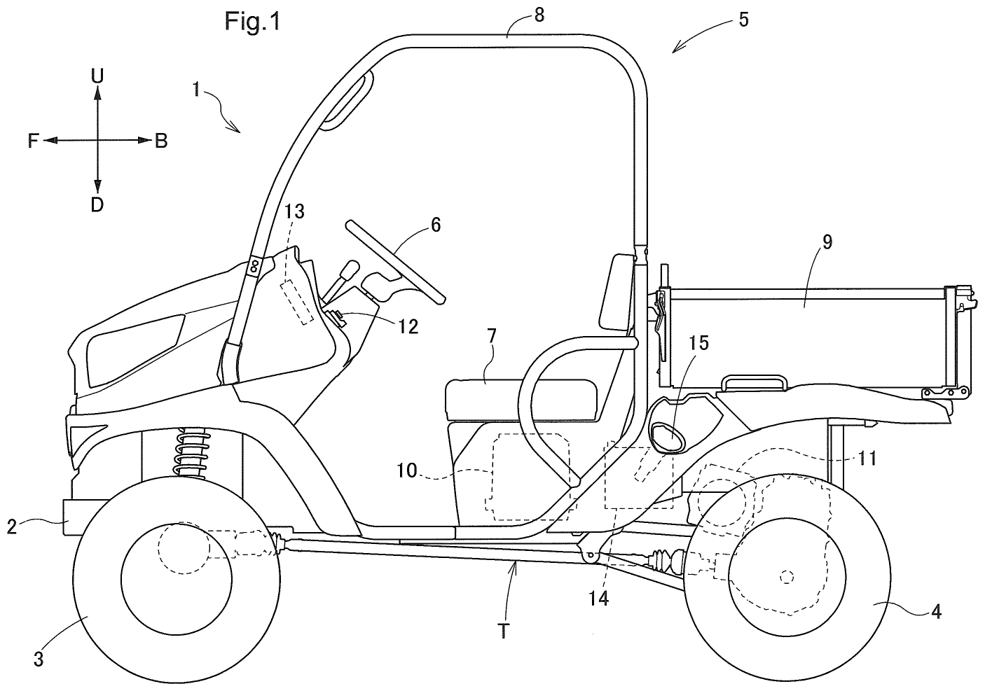

An electric work vehicle 1 illustrated in FIG. 1 is a utility vehicle. As illustrated in FIG. 1, the electric work vehicle 1 includes a body frame 2, right and left front wheels 3 (corresponding to a “travel device” according to the present invention), and right and left rear wheels 4 (corresponding to a “travel device” according to the present invention). The body frame 2, the right and left front wheels 3, and the right and left rear wheels 4 are provided at the bottom portion of the body of the electric work vehicle 1.

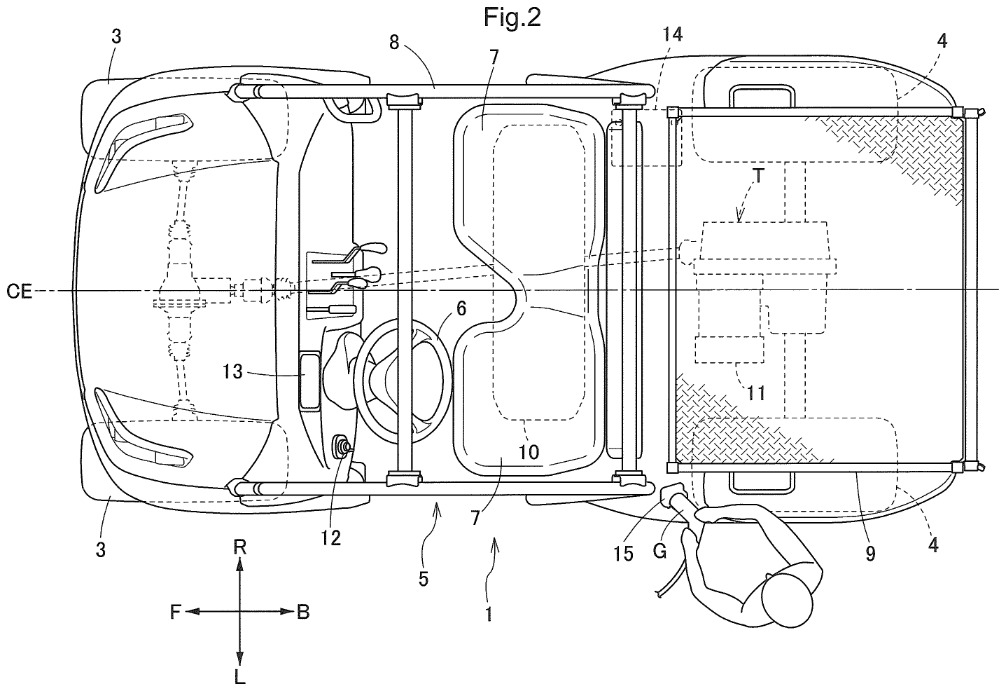

As illustrated in FIGS. 1, 2, the electric work vehicle 1 includes a cab unit 5 in which a user (an operator) can ride, at its central portion in the front-rear direction. The cab unit 5 includes a steering wheel 6, and right and left seats 7. In the present embodiment, the right and left seats 7 are integrally formed.

The steering wheel 6 is disposed forward of the left seat 7. The user can sit on the right and left seats 7. The user sitting down on the left seat 7 can steer the electric work vehicle 1 by operating the steering wheel 6.

The cab unit 5 includes a protection frame 8. The protection frame 8 is a ROPS (Rollover Protective Structure). The protection frame 8 is supported on the body frame 2. The protection frame 8 surrounds a cabin space (in the vicinity of or around the steering wheel 6 and the right and left seats 7) in the cab unit 5.

The electric work vehicle 1 includes a cargo bed 9. The cargo bed 9 is provided rearward of the cab unit 5. The cargo bed 9 can be loaded with articles (goods such as straw or farm products).

As illustrated in FIG. 1, the electric work vehicle 1 includes a first battery 10 (corresponding to the “battery” according to the present invention) and a motor 11. The first battery 10 and the motor 11 are mounted on the body frame 2. The first battery 10 is disposed under the right and left seats 7. The motor 11 is disposed under the cargo bed 9.

The first battery 10 is electrically connected to the motor 11. The motor 11 is driven by electric power supplied from the first battery 10. That is, the electric work vehicle 1 includes the first battery 10, and the motor 11 driven by electric power supplied from the first battery 10.

A driving force from the motor 11 is transmitted to the right and left front wheels 3 and the right and left rear wheels 4 via a power transmission mechanism T. As a result, the right and left front wheels 3 and the right and left rear wheels 4 are driven. Hereby, the electric work vehicle 1 can travel by the right and left front wheels 3 and the right and left rear wheels 4.

That is, the electric work vehicle 1 includes the right and left front wheels 3 and the right and left rear wheels 4 driven by the motor 11.

As illustrated in FIG. 2, the cab unit 5 includes a key switch 12 and a meter panel 13 (corresponding to the “notifier” according to the present invention). The key switch 12 and the meter panel 13 are disposed forward of the left seat 7.

In response to the key switch 12 being manually operated, the electric work vehicle 1 is switchable between a key-off state and a key-on state. More specifically, a key is insertable into the key switch 12. The user can operate the key switch 12 by turning (rotating) the key with the key being inserted into the key switch 12. In response to the key switch 12 being switched to an OFF position, the electric work vehicle 1 enters the key-off state. In response to the key switch 12 being switched to an ON position, the electric work vehicle 1 enters the key-on state.

The motor 11 is drivable while the electric work vehicle 1 is in the key-on state. That is, the electric work vehicle 1 can travel at this time.

The motor 11 cannot be driven while the electric work vehicle 1 is in the key-off state. That is, the electric work vehicle 1 cannot travel at this time.

The meter panel 13 is mounted to face the left seat 7. In other words, the meter panel 13 faces rearward in the body of the electric work vehicle 1.

The meter panel 13 can display various pieces of information, including the current vehicle speed of the electric work vehicle 1, for example. The meter panel 13 enters an ON state in response to the electric work vehicle 1 being switched from the key-off state to the key-on state. In the meantime, the meter panel 13 enters an OFF state in response to the electric work vehicle 1 being switched from the key-on state to the key-off state. Note that the ON state represents a state where various pieces of information are displayed, and the OFF state represents a state where no information is displayed.

Thus, the electric work vehicle 1 includes the meter panel 13 provided in the cab unit 5. Although not limited in particular, the meter panel 13 may be a liquid crystal display or an organic EL (Electro Luminescence) display or may include one or more analog meters.

As illustrated in FIG. 1, the electric work vehicle 1 includes a second battery 14. The second battery 14 supplies electric power to various auxiliary machines. Electric power is also supplied from the first battery 10 to a voltage converter (not illustrated). The voltage converter lowers the voltage of the electric power from the first battery 10 and supplies the electric power to the second battery 14.

The second battery 14 supplies electric power to the meter panel 13. The meter panel 13 operates on the electric power from the second battery 14. The meter panel 13 is one of the “various auxiliary machines.”

### Power Supply Unit

As illustrated in FIGS. 1, 2, the electric work vehicle 1 includes a power supply unit 15. The power supply unit 15 is disposed at the left end of the rear portion of the electric work vehicle 1. The power supply unit 15 is electrically connected to the first battery 10 via a harness (not illustrated).

As illustrated in FIG. 2, a charger G installed in a charging facility or the like is connectable to the power supply unit 15. The specifications of the charger G and the power supply unit 15 are not limited in particular but may be CHAdeMO, for example. The charger G is not included in the electric work vehicle 1.

In response to the charger G being connected to the power supply unit 15, electric power is supplied to the first battery 10. Hereby, the first battery 10 is charged.

Thus, the electric work vehicle 1 includes the power supply unit 15 electrically connected to the first battery 10 and connectable to the charger G.

A center line CE is drawn in FIG. 2. The center line CE indicates a central position of the body of the electric work vehicle 1 in its right-left direction. As illustrated in FIG. 2, the steering wheel 6, the left seat 7, the key switch 12, the meter panel 13, and the power supply unit 15 are disposed to the left of the center line CE.

That is, the steering wheel 6, the left seat 7, the key switch 12, the meter panel 13, and the power supply unit 15 are disposed on the same side relative to the central position of the body in the right-left direction. Particularly, the power supply unit 15 and the meter panel 13 are disposed on the same side relative to the central position of the body in the right-left direction.

As illustrated in FIG. 2, the power supply unit 15 is disposed rearward of the meter panel 13.

At the time when the user connects the charger G to the power supply unit 15, the user is positioned on the left side of the rear portion of the electric work vehicle 1 as illustrated in FIG. 2. The electric work vehicle 1 is configured such that there is no obstruction in the user's line of sight toward the meter panel 13 (nothing obstructs the user's view of the meter panel 13) while the user is standing in that position (the position where the user stands to connect the charger G).

### Charging Determination Unit and Display Control Unit

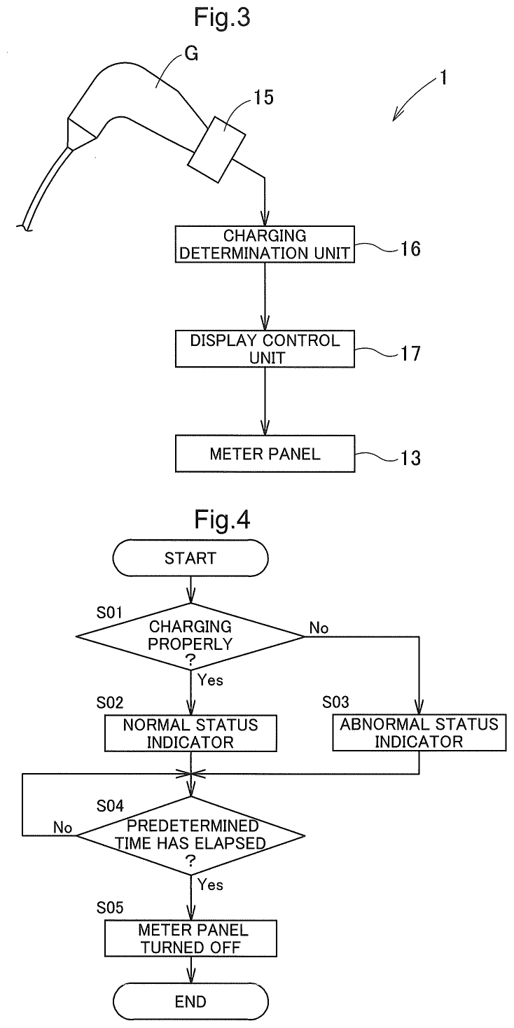

As illustrated in FIG. 3, the electric work vehicle 1 includes a charging determination unit 16 and a display control unit 17 (corresponding to the “notification control unit” according to the present invention). While the charger G is connected to the power supply unit 15, the charging determination unit 16 acquires charging related information from the power supply unit 15. The charging related information is information on charging from the charger G to the first battery 10. The charging related information may be information indicative of the current (the current value) between the charger G and the first battery 10 or may be information indicating that the charger G exhibits a failure or other malfunction, for example. The charging related information may be output (or generated) by the charger G and sent to the charging determination unit 16 via the power supply unit 15, for example.

The charging determination unit 16 determines whether or not the first battery 10 is being charged normally, based on the charging related information acquired from the power supply unit 15. That is, the electric work vehicle 1 includes the charging determination unit 16 configured to determine whether or not the first battery 10 is being charged normally while the charger G is connected to the power supply unit 15.

For example, in the case where the charging related information is information indicative of the current (the current value) between the charger G and the first battery 10, when the electric current (the current value) is within a normal range, the charging determination unit 16 determines that the first battery 10 is being charged normally.

In the meantime, in the case where the charging related information indicates that the charger G exhibits a failure or other malfunction, for example, the charging determination unit 16 determines that the first battery 10 is not being charged normally.

As illustrated in FIG. 3, the determination result from the charging determination unit 16 is sent to the display control unit 17. In response to the charger G being connected to the power supply unit 15 with the electric work vehicle 1 being in the key-off state, the display control unit 17 controls the meter panel 13 based on the determination result. That is, the electric work vehicle 1 includes the display control unit 17 configured to control the meter panel 13.

Note that the charging determination unit 16 and the display control unit 17 may be a physical device such as a microcomputer or may be a functional unit in software.

### Display Control Flow

The electric work vehicle 1 is configured to control the meter panel 13 in accordance with the display control flow illustrated in FIG. 4. The following describes details of the display control flow.

In response to the charger G being connected to the power supply unit 15 with the electric work vehicle 1 being in the key-off state, the display control flow illustrated in FIG. 4 starts. Note that, as described above, the meter panel 13 is turned off in response to the electric work vehicle 1 being switched from the key-on state to the key-off state. Therefore, at the start of the display control flow, the meter panel 13 is in the OFF state.

When the display control flow starts, the process in step S01 is executed first. In step S01, the charging determination unit 16 determines whether or not the first battery 10 is being charged normally, as described above. In a case where the first battery 10 is being charged normally (“Yes” in step S01), the process proceeds to step S02. In a case where the first battery 10 is not being charged normally (“No”in step S01), the process proceeds to step S03.

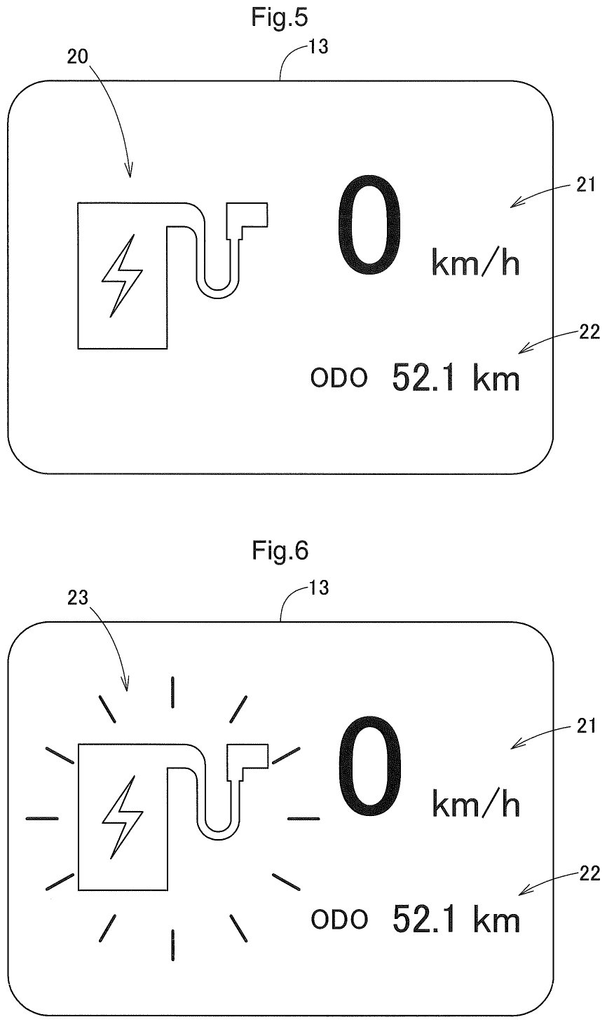

In step S02, the display control unit 17 automatically turns on the meter panel 13 and causes the meter panel 13 to automatically display a normal status indicator 20 (see FIG. 5). The normal status indicator 20 is an indicator indicating that the first battery 10 is being charged normally. After that, the process proceeds to step S04.

Although not limited in particular, the normal status indicator 20 in the present embodiment is an icon in a lit state, as illustrated in FIG. 5. The icon is shaped like the charger G. The icon may be green, for example.

In the present embodiment, a vehicle speed meter 21 and an odometer 22 are displayed on the meter panel 13 in the ON state, as illustrated in FIG. 5. The vehicle speed meter 21 displays the current vehicle speed of the electric work vehicle 1. The odometer 22 displays the total driving distance of the electric work vehicle 1. As illustrated in FIG. 5, the normal status indicator 20 is displayed together with an indicator (for example, the vehicle speed meter 21 and the odometer 22) indicating the state (for example, the vehicle speed or the total driving distance) of the electric work vehicle 1.

Thus, in the case where the first battery 10 is being charged normally while the charger G is connected to the power supply unit 15 with the electric work vehicle 1 being in the key-off state, the display control unit 17 causes the meter panel 13 to display the normal status indicator 20 indicating that the first battery 10 is being charged normally.

In step S03 in FIG. 4, the display control unit 17 automatically turns on the meter panel 13 and causes the meter panel 13 to automatically display an abnormal status indicator 23 (see FIG. 6). The abnormal status indicator 23 is an indicator indicating that the first battery 10 is not being charged normally. After that, the process proceeds to step S04. Note that the displaying of the abnormal status indicator 23 is a specific example of the “abnormality notification” according to the present invention.

Although not limited in particular, the abnormal status indicator 23 in the present embodiment is an icon in a flashing state, as illustrated in FIG. 6. The icon is shaped like the charger G. The icon may be red, for example.

As illustrated in FIG. 6, the abnormal status indicator 23 is displayed together with an indicator (for example, the vehicle speed meter 21 and the odometer 22) indicating the state (for example, the vehicle speed or the total driving distance) of the electric work vehicle 1.

In the case where the first battery 10 is not being charged normally while the charger G is connected to the power supply unit 15 with the electric work vehicle 1 being in the key-off state, the display control unit 17 causes the meter panel 13 to display the abnormal status indicator 23 indicating that the first battery 10 is not being charged normally.

In step S04 in FIG. 4, the display control unit 17 determines whether or not a predetermined time has elapsed since the start of the display of the normal status indicator 20 or the abnormal status indicator 23 on the meter panel 13. In a case where the predetermined time has elapsed (“Yes” in step S04), the process proceeds to step S05. In a case where the predetermined time has not elapsed (“No” in step S04), step S04 is executed again.

That is, until the predetermined time elapses after the process proceeds to step S04 for the first time, the process of step S04 is executed repeatedly. Then, in response to the elapse of the predetermined time, the process proceeds to step S05. Note that the predetermined time is not limited but may be 30 seconds, for example.

In step S05, the display control unit 17 automatically turns off the meter panel 13. Hereby, the normal status indicator 20 or the abnormal status indicator 23, the vehicle speed meter 21, and the odometer 22 displayed on the meter panel 13 are automatically turned off (in other words, they are not displayed). After that, the display control flow is ended.

Thus, the display control unit 17 turns off the meter panel 13 after the predetermined time has elapsed since the start of the display of the abnormal status indicator 23 (or the normal status indicator 20).

With the configuration described above, in the case where the first battery 10 is not being charged normally while the charger G is connected to the power supply unit 15 with the electric work vehicle 1 being in the key-off state, abnormality notification (the display of the abnormal status indicator 23) is performed. This allows the user to easily notice that the first battery 10 is not being charged normally.

Accordingly, with the configuration described above, it is possible to achieve the electric work vehicle 1 that allows the user to easily notice that the first battery 10 is not being charged normally in a case where the first battery 10 is not being charged normally while the charger G is connected to the power supply unit 15 with the electric work vehicle 1 being in the key-off state.

### Other Embodiments

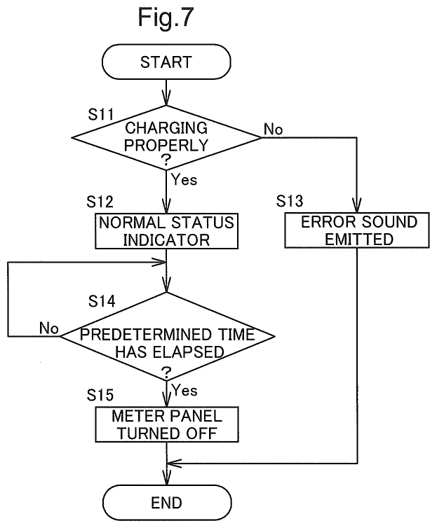

(1) The steering wheel 6, the left seat 7, the key switch 12, the meter panel 13, and the power supply unit 15 may be disposed to the right of the center line CE.
(2) The power supply unit 15 and the meter panel 13 may be respectively disposed to the right and the left of the center line CE.
(3) The normal status indicator 20 may be a sign, a message, or the like indicating that the first battery 10 is being charged normally and may be displayed in the flashing state.
(4) The abnormal status indicator 23 may be a sign, a message, or the like indicating that the first battery 10 is not being charged normally and may be displayed in the lit state.
(5) In the display control flow illustrated in FIG. 4, some steps may be omitted, or a new step may be added thereto. For example, step S02 may be omitted, or step S04 and step S05 may be omitted.
(6) The power supply unit 15 may be disposed forward of the meter panel 13.
(7) The arrangement of some of or all of the members may be reversed in the right-left direction.
(8) The electric work vehicle 1 may include an audio output device (corresponding to the “notifier” according to the present invention) (not illustrated), and an audio control unit (corresponding to the “notification control unit” according to the present invention) (not illustrated) configured to control the audio output device, and the electric work vehicle 1 may be configured to control the meter panel 13 and the audio output device in accordance with the display control flow illustrated in FIG. 7. The audio output device may be a buzzer, for example.

In response to the charger G being connected to the power supply unit 15 with the electric work vehicle 1 being in the key-off state, the control flow illustrated in FIG. 7 starts. When the control flow starts, the process in step S11 is executed first.

The process contents of steps S11, S12, S14, and S15 in FIG. 7 are similar to steps S01, S02, S04, and S05 in FIG. 4, respectively. Therefore, the following describes details of step S13.

In a case where the first battery 10 is not being charged normally (“No” in step S11), the process proceeds to step S13. In step S13, the audio control unit causes the audio output device to automatically output (emit) an error sound. The error sound indicates that the first battery 10 is not being charged normally. After that, this control flow is ended. Note that the output of the error sound is a specific example of the “abnormality notification” according to the present invention.

The configurations of the embodiments described above (including other embodiments, the same also applies hereinafter) may be combined with the configurations disclosed in the other embodiments as long as no inconsistency occurs. The embodiments described in the present specification are illustrative and should not be construed as limiting the present invention. Modifications to the present invention are permissible, as long as they do not deviate from the scope that can achieve the objects of the present invention.

### Industrial Applicability

The present invention is applicable to an electric work vehicle including a battery, and a motor driven by electric power supplied from the battery.

### Description of the Reference Numerals

1: electric work vehicle
3: front wheel (travel device)
4: rear wheel (travel device)
5: cab unit
10: first battery (battery)
11: motor
13: meter panel (notifier)
15: power supply unit
16: charging determination unit
17: display control unit (notification control unit)
20: normal status indicator
23: abnormal status indicator
G: charger

What is claimed is:

1. An electric work vehicle, comprising:
a battery;
a motor drivable by electric power supplied from the battery;
a travel device drivable by the motor;
a power supply unit electrically connected to the battery and connectable to a charger;
a notifier;
a notification control unit configured to control the notifier; and
a charging determination unit configured to determine whether or not the battery is being charged normally while the charger is connected to the power supply unit, and
wherein the notification controller is configured to, in response to the battery not being charged normally while the charger is connected to the power supply unit with the electric work vehicle being in a key-off state, cause the notifier to provide an abnormality notification for notification that the battery is not being charged normally.

2. The electric work vehicle according to claim 1, further comprising:
a driving section,
wherein the notifier is a meter panel provided in the driving section, and
wherein the notification control unit is a display control unit configured to control the meter panel in such a manner as to cause the meter panel to display, as the abnormality notification, an abnormal status indicator indicating that the battery is not being charged normally.

3. The electric work vehicle according to claim 2, wherein:
the display control unit turns off the meter panel after a predetermined time has elapsed since start of the display of the abnormal status indicator.

4. The electric work vehicle according to claim 2, wherein:
the display controller is configured to, in response to the battery being charged normally while the charger is connected to the power supply unit with the electric work vehicle being in the key-off state, cause the meter panel to display a normal status indicator indicating that the battery is being charged normally.

5. The electric work vehicle according to claim 2, wherein:
the power supply unit and the meter panel are disposed on an identical lateral side of a lateral center of a body of the electric work vehicle.

6. The electric work vehicle according to claim 2, wherein:
the power supply unit is disposed rearward of the meter panel.

7. The electric work vehicle according to claim 1, wherein:
the notifier is an audio output device, and
the notification control unit is an audio control unit configured to control the audio output device in such a manner as to cause the audio output device to output, as the abnormality notification, an error sound indicating that the battery is not being charged normally.
